(19) United States
(12) Patent Application Publication
(10) Pub. No.: US 2023/0334920 A1
(43) Pub. Date: Oct. 19, 2023

(54) SYSTEMS AND METHODS USING AN INTERACTIVE CLUSTER AND/OR SMART TILE APPROACH TO VEHICLE HEALTH ALERTS

(71) Applicant: Ford Global Technologies, LLC, Dearborn, MI (US)

(72) Inventors: John Brewer, Holly, MI (US); Ravikanth Mudduluru, Southfield, MI (US); Roy S. McKinstry, Northville, MI (US); Alekhya Santosh Ratnala, Novi, MI (US); Venkat Aekka, Canton, MI (US)

(73) Assignee: Ford Global Technologies, LLC, Dearborn, MI (US)

(21) Appl. No.: 17/659,697

(22) Filed: Apr. 19, 2022

(51) Int. Cl. G07C 5/08; B60K 35/00

(52) U.S. Cl. CPC G07C 5/0825; B60K 35/00; G06F 3/04817

(57) ABSTRACT

This disclosure describes systems and methods using an interactive cluster and/or smart tile approach to vehicle health alerts. An example method may include presenting, through a first user interface of a device, an image of a display being presented on a digital vehicle cluster, the image of the display including a first icon corresponding to a first malfunction indicator lamp (MIL) being presented on the digital vehicle cluster. The example method may also include receiving, through the first user interface of the device, a selection of the first icon. The example method may also include presenting a second user interface of the device including information relating to the first MIL.

### BACKGROUND

Interactive cluster feedback is not currently supported across multiple OEMs for vehicle health alerts. A vehicle health alert may have the ability to detect a diagnostic trouble code (DTC) in a vehicle and communicate this information to a user (for example, through a mobile device application). The vehicle health alert may also provide other types of information to the user, such as battery life, time remaining until the next oil change, etc. However, merely presenting this information to the user may not be sufficient. For example, even if a DTC is presented to the user, the user may not understand what the DTC means and what action needs to be taken to address the DTC. As one non-limiting example, if a brake light Malfunction Indicator Lamp (MIL) or Warning Indicator Lamp (WIL) were to appear, some users would not believe or trust that there is an issue with the vehicle and may ignore the DTC and continue driving.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 illustrates an example use case, in accordance with one or more embodiments of the disclosure.

FIG. 2 illustrates an example use case, in accordance with one or more embodiments of the disclosure.

FIG. 3 illustrates an example use case, in accordance with one or more embodiments of the disclosure.

FIG. 4 illustrates an example use case, in accordance with one or more embodiments of the disclosure.

FIG. 5 illustrates an example user interface, in accordance with one or more embodiments of the disclosure.

FIG. 6 illustrates an example method, in accordance with one or more embodiments of the disclosure.

FIG. 7 illustrates an example of a system, in accordance with one or more embodiments of this disclosure.

FIG. 8 illustrates an example of a computing system, in accordance with one or more embodiments of this disclosure.

### DETAILED DESCRIPTION

This disclosure relates to, among other things, systems and methods using an interactive cluster and/or smart tile approach to vehicle health alerts.

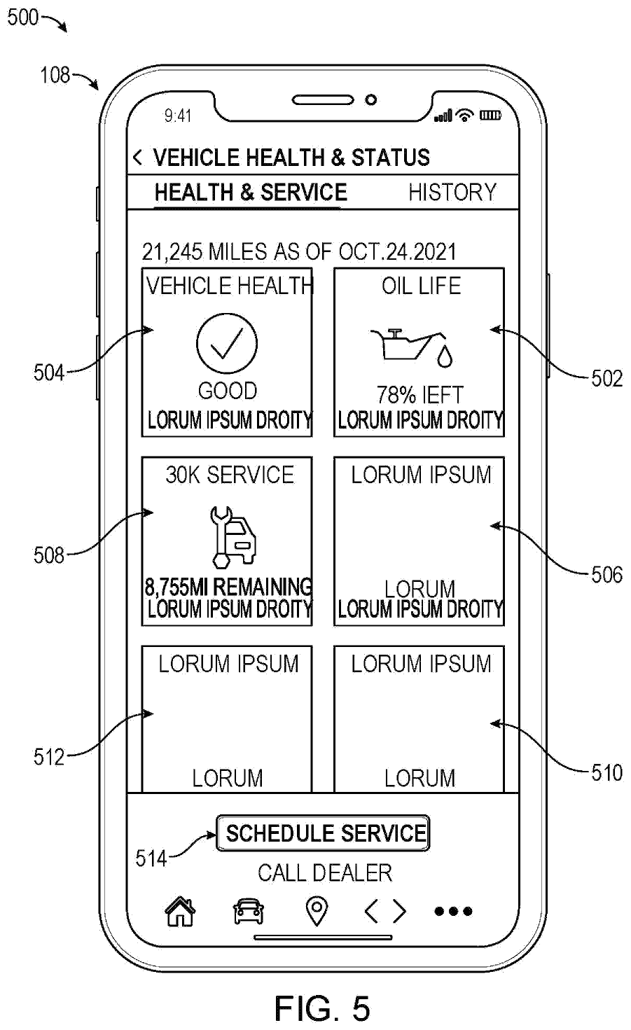

In one or more embodiments, a vehicle (and/or any systems or devices in communication with the vehicle) may use vehicle health alerts to monitor a status of the vehicle. A vehicle health alert may have the ability to detect a diagnostic trouble code (DTC) in a vehicle and communicate this information to a user (for example, through a mobile device application). The vehicle health alert may also provide other types of information to the user, such as battery life, time remaining until the next oil change, etc. This information may be presented to a user through a mobile device application, through a human-machine interface (HMI) of the vehicle, and/or through any other system or device. In some cases (for example, as illustrated in FIG. 5), the information may be presented to the user through “smart tiles.” Individual smart tiles may provide information about different vehicle systems. As a few non-limiting examples, one tile may tire pressure information, one may provide general service interval reminders, one may provide oil remaining life, and/or any other types of information.

In some vehicles, when a DTC is detected indicating a potential problem with the vehicle, an indicator light (for example, a MIL and/or WIL, which may be referred to interchangeably herein) may illuminate on the cluster of the vehicle to indicate the potential problem to a user. While these icons may indicate to the user that a general problem exists, the user may not have any additional information beyond this mere indication. In such cases, a user may be able to obtain additional information about the DTC using a device that interfaces with an On-Board Diagnostics (OBD) port of the vehicle to gather data from the Controller Area Network (CAN) bus of the vehicle. The device may be capable of obtaining the DTC code and presenting it to the user. This information may also be displayed as a vehicle health alert through the mobile device application or other location where the vehicle health alert may be presented. However, these additional steps may add complexity to the troubleshooting process and still may provide insufficient information to a user that is not able to diagnose a problem based on a DTC alone.

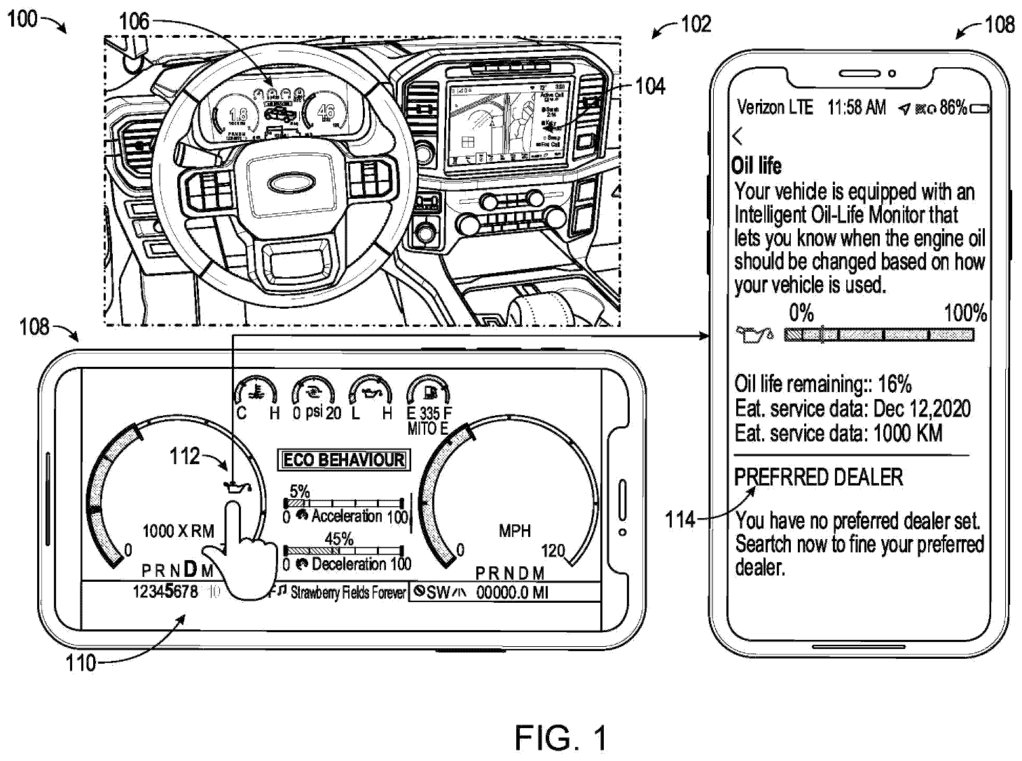

In one or more embodiments, the systems and methods described herein provide a more user-friendly approach to presenting such DTCs and any associated information to the user. To accomplish this, a replicated interactive image of the in-vehicle cluster experience may be produced and presented to the user separately from the in-vehicle cluster. For example, the replicated interactive image may be displayed on the mobile device application. In some cases, the replicated image may be an exact replica of the in-vehicle cluster. However, in other cases, some elements of the cluster image presented on the mobile device application may differ from similar elements presented on the in-vehicle cluster. Using this replicated interactive image, the user may be able to select the indicator light that is being displayed on the vehicle cluster and the application may then provide more comprehensive information about the associated DTC to the user. The application may also provide capabilities for the user to initiate a process to resolve the problem, such as directing the user to a website to purchase a vehicle component, schedule maintenance for the vehicle, and/or may provide any other types of information that may allow the user to resolve the problem themselves. Examples of types of information that may be presented to the user (and the various formats in which such information may be presented) are provided with respect to at least FIGS. 1-4.

In one or more embodiments, the replicated interactive image may be presented on the device using a number of different approaches. For example, a collection of vehicle cluster images associated with different types of vehicles may be stored within a database. When a user desires to view the vehicle cluster through the mobile device application, an image representing the current state of the in-vehicle cluster may be obtained and provided to the mobile device application for presentation to the user. To determine which image to provide to the mobile device application, a vehicle identifier may be employed. For example, a vehicle identification number (VIN) may be used to determine which image of the collection of images stored on the database pertains to the user's vehicle. For example, the database may include one or more images depicting a vehicle cluster associated with a first vehicle model and one or more images depicting a vehicle cluster associated with a second vehicle model. If the user's vehicle is the first vehicle model, then the VIN may be used to identify the images within the database that relate to the first vehicle model instead of the second vehicle model. In some cases, the VIN may be associated with an illustrator or Computer-Aided-Design (CAD) drawing. The vehicle health alert cluster may be different for each user based on this VIN (however, in some cases, some or all clusters may also be the same as well). The dimensions of the cluster may be specified based on the VIN. For example, different types of vehicles may be associated with different-sized clusters, so the dimensions may vary depending on the vehicle. This drawing that is specific to the particular vehicle may then be obtained and provided to the mobile device application.

Additionally, in one or more embodiments, an image that is provided to the mobile device application may actually include a collection of images representing different portions of the vehicle cluster. That is, the database may include a “default” vehicle cluster image. Additional images may then be provided as overlays on top of the default image to represent dynamic aspects of the vehicle cluster. For example, the database may also include engine oil status images, speedometer images, MIL/WIL images, and/or any other types of images. In this manner, the default image may be overlaid with any MIL/WIL images (and/or any other images associated with other elements of the cluster) and presented on the mobile device application. This may allow for images of smaller image sizes to be stored in the database for dynamic vehicle cluster elements, rather than storing individual images of the full vehicle cluster for every possible combination of possible scenarios.

Furthermore, in one or more embodiments, the image that is presented on the mobile device application may alternatively include data that is provided directly from the vehicle. For example, the data that is used by the vehicle to present the in-vehicle cluster may be captured and provided to the mobile device for presentation. In this manner, the same data that is being used to present the in-vehicle cluster may be used to present the mobile device application duplicate of the in-vehicle cluster rather than using separate images that are stored in a database. The presentation of the cluster through the mobile device application may also be performed in any other manner other than those described herein as well.

In one or more embodiments, the replica of the in-vehicle cluster may be provided to any other types of devices and/or number of devices as well. For example, the replica of the in-vehicle cluster may be presented on another display of the vehicle, such as an HMI associated with a center console of the vehicle. In some cases, a user may be able to more easily interact with this vehicle HMI (and/or the in-vehicle cluster may not have the capability for user interaction). In these cases, it may be beneficial to display the replica on this HMI to allow the user to enact with the in-vehicle cluster through the HMI instead. The replica of the in-vehicle cluster may also be provided to a third party, such as a customer help center for presentation through a device associated with the third party. For example, if the user is interacting with a customer help center to diagnose a vehicle status, an operator at the customer help center may be able to view the replica of the in-vehicle cluster to better assist the user. The replica of the in-vehicle cluster may be presented on any of these different devices at any number of different locations simultaneously as well.

The systems and methods described herein may provide a number of different benefits. For example, the systems and methods may allow for a digital vehicle cluster to be replicated onto a display of another device (in real-time in some instances), where a user is able to interact with the replicated digital vehicle cluster through the other device. This may allow the user to be able to more conveniently obtain information about any MIL/WIL being presented on the in-vehicle cluster without having to interact with the in-vehicle cluster itself. This may also provide the benefit of allowing the user to view a replica of the cluster without having to be inside the vehicle. The systems and methods may also be beneficial in that any MIL/WIL that is being presented on the in-vehicle cluster may be presented in the exact same location on the replicated digital vehicle cluster being presented on the device. The user may be able to interact with this MIL/WIL to obtain additional information about what the MIL/WIL indicates about the vehicle status, how the MIL/WIL may potentially be addressed, and be directed to websites or other sources for purchasing products to remedy a vehicle status and/or scheduling a service to be performed on the vehicle. This may provide a more comprehensive, user-friendly experience for the user to allow them to better diagnose and solve a potential issue associated with a MIL/WIL through a single application.

Turning to the figures, FIG. 1 illustrates an example use case 100, in accordance with one or more embodiments of the disclosure.

In one or more embodiments, the use case 100 may illustrate one example of a particular MIL/WIL that may be illuminated on a cluster 106 of a vehicle 102, and how the systems and methods described herein (for example, through the use of the mobile device 108 application) may be used by the user to obtain additional information about the MIL/WIL illuminated on the cluster 106.

In one or more embodiments, the vehicle 102 may include any type of vehicle (for example, electric vehicle, hybrid vehicle, internal combustion engine vehicle, autonomous or semi-autonomous vehicle, etc.). The vehicle 102 may include a cluster 106. The cluster 106 may be digital or analog and may present various types of information to a user. For example, the cluster 106 may include a tachometer to provide an indication of engine rotations per minute (RPMs), a speedometer to provide an indication of vehicle speed, an odometer to provide an indication of a number of vehicle miles, and/or any other types of information that may be relevant to the user. Additionally, the cluster 106 may, in some cases, present one or more MILs. A MIL may be presented based on a DTC being active in the vehicle. For example, if a low oil DTC is active in the vehicle, then a MIL associated with the low oil DTC may illuminate on the cluster to provide an indication to the user that the vehicle's oil may need to be changed. The vehicle may also include an HMI 104. The HMI 104 may provide a display through which the user may interact with certain vehicle systems and/or be presented with information. For example, the HMI 104 may allow the user to perform navigation functions, control a radio of the vehicle, and/or perform any other functions. In some cases, the information displayed on the cluster 106 may also be displayed on the HMI as well. For example, vehicle speed, RPMs, and/or any other types of information may also be displayed on the HMI 104.

In one or more embodiments, the mobile device 108 may present a user interface 110 through an application associated with the mobile device 108. The user interface 110 may include presentation of the exact cluster 106 that is presented in the vehicle 102 to the user. This may provide a more user-friendly experience, as the user may be able to view the exact cluster they may also view within the vehicle 102, including the same MIL 112 at the same location that they may appear through the cluster 106 in the vehicle 102. The user may also be able to interact with certain elements within the user interface 110. For example, the user interface 110 may be configured to allow the user to select the MIL 112, as well as various other elements of the user interface 110.

In one or more embodiments, the replicated interactive image may be presented on the device using a number of different approaches. For example, a collection of vehicle cluster images associated with different types of vehicles may be stored within a database. When a user desires to view the in-vehicle cluster 106 through the mobile device application, an image representing the current state of the in-vehicle cluster 106 may be obtained and provided to the mobile device application for presentation to the user. To determine which image to provide to the mobile device application, a vehicle identifier may be employed. For example, a vehicle identification number (VIN) may be used to determine which image of the collection of images stored on the database pertains to the user's vehicle. For example, the database may include one or more images depicting a vehicle cluster associated with a first vehicle model and one or more images depicting a vehicle cluster associated with a second vehicle model. If the user's vehicle is the first vehicle model, then the VIN may be used to identify the images within the database that relate to the first vehicle model instead of the second vehicle model. In some cases, the VIN may be associated with an illustrator or Computer-Aided-Design (CAD) drawing. The vehicle health alert cluster may be different for each user based on this VIN (however, in some cases, some or all clusters may also be the same as well). The dimensions of the cluster may be specified based on the VIN. For example, different types of vehicles may be associated with different-sized clusters, so the dimensions may vary depending on the vehicle. This drawing that is specific to the particular vehicle may then be obtained and provided to the mobile device application.

Additionally, in one or more embodiments, an image that is provided to the mobile device application may actually include a collection of images representing different portions of the vehicle cluster. That is, the database may include a “default” vehicle cluster image. Additional images may then be provided as overlays on top of the default image to represent dynamic aspects of the vehicle cluster. For example, the database may also include engine oil status images, speedometer images, MIL/WIL images, and/or any other types of images. In this manner, the default image may be overlaid with any MIL/WIL images (and/or any other images associated with other elements of the cluster) and presented on the mobile device application. This may allow for images of smaller image sizes to be stored in the database for dynamic vehicle cluster elements, rather than storing individual images of the full vehicle cluster for every possible combination of possible scenarios.

Furthermore, in one or more embodiments, the image that is presented on the mobile device application may alternatively include data that is provided directly from the vehicle. For example, the data that is used by the vehicle to present the in-vehicle cluster 106 may be captured and provided to the mobile device for presentation. In this manner, the same data that is being used to present the in-vehicle cluster may be used to present the mobile device application duplicate of the in-vehicle cluster 106 rather than using separate images that are stored in a database. The presentation of the cluster through the mobile device application may also be performed in any other manner other than those described herein as well.

In one or more embodiments, upon selection of the MIL 112, the user may be presented with information that is specific to that particular MIL 112. That is, the application associated with the mobile device 108 may present a second user interface 114 including such information. For example, in the use case 100, an oil MIL 112 may be illuminated. Upon the selection of the MIL 112 by the user, the second user interface 114 may be presented to the user providing additional information about the oil MIL 112. For example, the second user interface 114 may indicate what information the oil MIL 112 is intended to provide to the user. The example shown in the second user interface 114 indicates that the oil MTh 112 is an “oil-life monitor” that informs a user when the engine oil should be changed based on vehicle usage. The second user interface 114 may also present any additional information that may be useful for the user, such as an exact amount of oil life remaining (which may be presented in any format, such as a percentage, an amount of time, a number of quarts, etc.), an estimated date by which the user should perform an oil service on the vehicle 102, an estimated distance the user may drive before the oil service may need to be performed, etc. Finally, the second user interface 114 may provide access to service providers in the area that may be capable of servicing the oil of the vehicle 102. Alternatively, the second user interface 114 may provide links to allow the user to purchase oil, an oil filter, and any other items necessary to perform the oil service, if the user desires to perform the service themselves. The mobile device application may allow the user to save favorite service providers, product websites, etc. for ease of use at the time of a subsequent oil service.

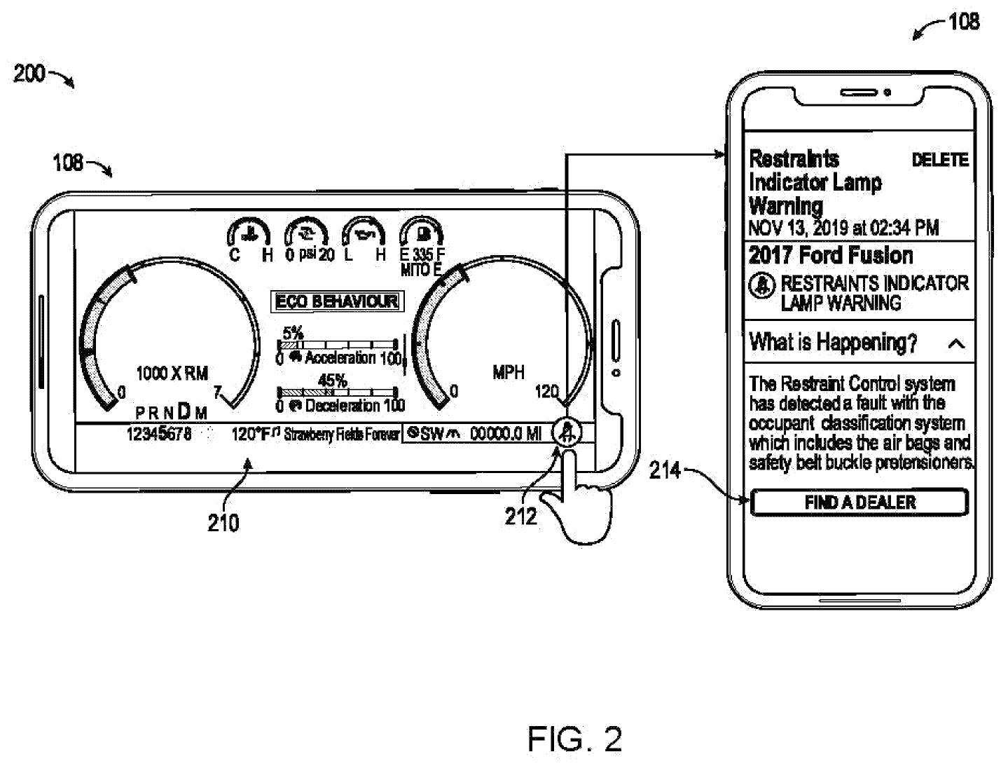

FIG. 2 illustrates an example use case 200, in accordance with one or more embodiments of the disclosure.

In one or more embodiments, the use case 200 may present another example type of MIL 212 that may be presented to a user through a user interface 210 of the mobile device 108. In this particular example, a restraints MIL 212 may be presented to the user. Upon selection of the restraints MIL 212, the user may be presented a second user interface 214 including additional information about the restraints MIL 212. For example, the second user interface 214 may provide a name associated with the restraints MIL 212, a date at which the restraints MIL 212 first illuminated, as well as information about the restraints MIL 212. The example information presented in the second user interface 214 indicates that a restraint control system detected a fault with an occupant classification system, which includes airbags and safety buckle pretensions. The second user interface 214, similar to the second user interface 114, may also present one or more links to the user to allow the user to find a dealer from which the user may purchase any replacement components that may be required. The second user interface 114 may also provide links for the user to schedule a service on the vehicle to confirm the source of the DTC associated with the restraints MIL 212. The second user interface 214 may also allow a user to manually clear the DTC and stop the restraints MIL 212 from illuminating. The second user interface 114 may also provide information about how the user may address the restraints MIL 212 themselves. For example, a link to a user manual may be provided that includes step-by-step instructions regarding how to address the problem.

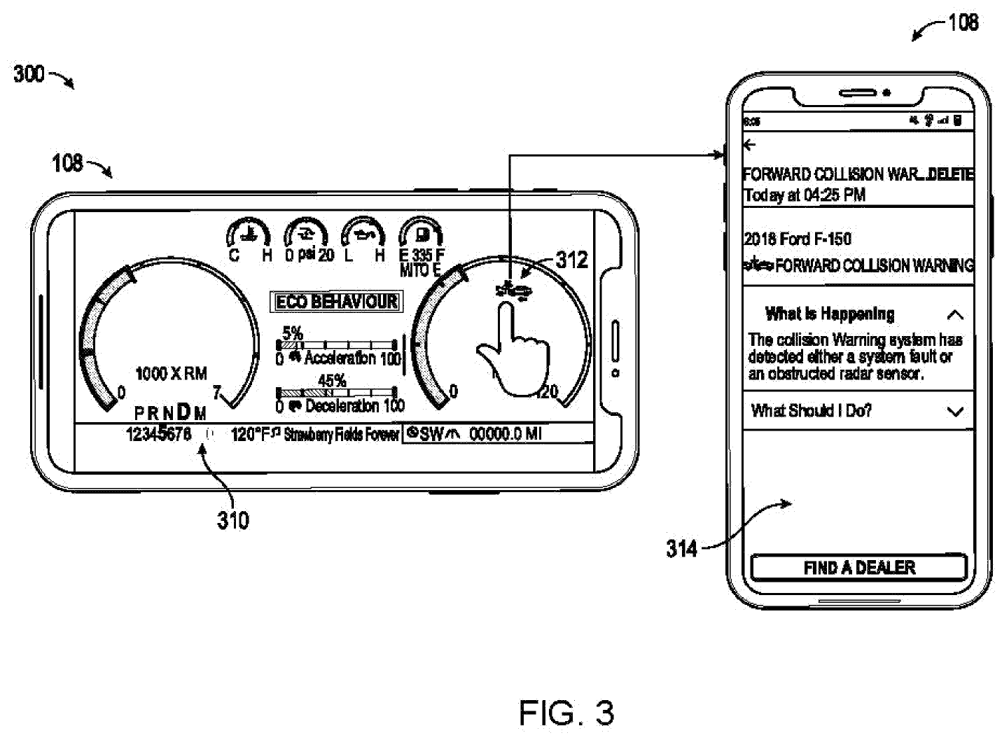

FIG. 3 illustrates an example use case 300, in accordance with one or more embodiments of the disclosure.

In one or more embodiments, the use case 300 may present another example type of MIL 312 that may be presented to a user through a user interface 310 of the mobile device 108. In this particular example, a forward collision warning MIL 312 may be presented to the user. Upon selection of the forward collision warning MIL 312, the user may be presented a second user interface 314 including additional information about the forward collision warning MIL 312. For example, the second user interface 314 may provide a name associated with the forward collision warning MIL 312, a date at which the forward collision warning MIL 312 first illuminated, as well as information about the forward collision warning MIL 312. The example information presented in the second user interface 314 indicates that a collision warning system detected a system fault or an obstructed radar sensor. The second user interface 314 may also include information about potential approaches a user may take to solve the problem. For example, the second user interface 214 may provide instructions for the user to self-troubleshoot the issue (for example, checking the sensors for obstruction, etc.). The second user interface 314, similar to the second user interface 214 and the second user interface 114, may also present one or more links to the user to allow the user to find a dealer from which the user may purchase any replacement components that may be required. The second user interface 314 may also provide links for the user to schedule a service on the vehicle to confirm the source of the DTC associated with the forward collision warning MIL 312. The second user interface 314 may also allow a user to manually clear the DTC and stop the forward collision warning MIL 312 from illuminating.

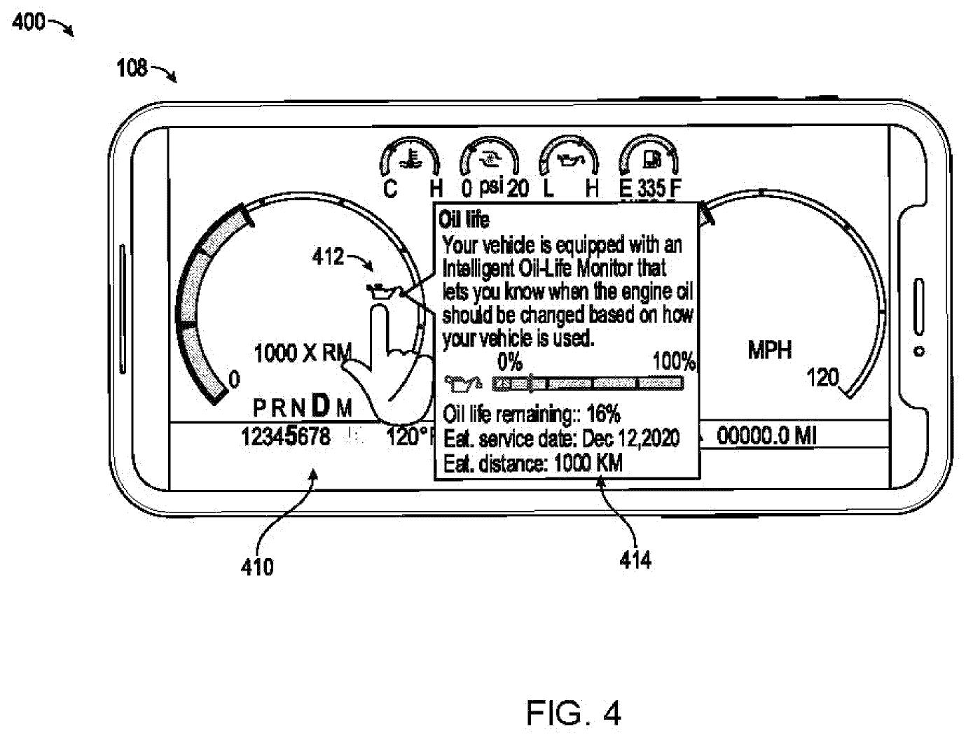

FIG. 4 illustrates an example use case 400, in accordance with one or more embodiments of the disclosure.

In one or more embodiments, the use case may be similar to the use case 100. That is, in the use case 400, an oil MIL 412 may be illuminated. Upon the selection of the MIL 412 by the user, a second user interface 414 may be presented to the user providing additional information about the oil MIL 412. However, the use case 400 may differ from the use case 100 in that the second user interface 414 may be presented as a popup box instead of encompassing the entire display of the mobile device application. This use case 400 serves to illustrate that the second user interface presented after the user selects the MIL may not necessarily be limited to any one presentation format. In this example, the popup box format allows the user to view the information about the oil MIL 412, while still also being able to view the user interface 410 including the presentation of the replica of the in-vehicle cluster. It should be noted that the second user interface may also be presented in any other format as well. As one additional non-limiting example, the second user interface may be presented side-by-side on the display with the first user interface.

It should be noted that any of the user interfaces described with respect to FIGS. 1-4 may merely be exemplary, and any other types of information may also be displayed on any of the user interfaces associated with any of the use cases. Additionally, any information that is illustrated as being presented on one user interface associated with one use case may also be presented on another user interface associated with a different use case, even if this information is not necessarily illustrated in the user interface associated with that particular use case. Finally, the use cases illustrated and described herein and merely exemplary and are not intended to be limiting in any way. These systems and methods may also be applicable to any other MIL/WIL that is not illustrated or described herein.

FIG. 5 illustrates an example user interface 500, in accordance with one or more embodiments of the disclosure.

In one or more embodiments, the user interface 500 may depict another example user interface that may be associated with an application through which the replica of the in-vehicle cluster may be displayed. In the example illustrated in the figure, the user interface 500 may include a collection of “smart tiles” (for example, smart tile 502, smart tile 504, smart tile 506, smart tile 508, smart tile 510, smart tile 512, and/or any other number of smart tiles).

In one or more embodiments, the smart tiles may be icons that are presented through the user interface 500 that may provide information about a status of the vehicle as a while, as well as individual components of a vehicle. For example, the smart tile 502 presents information about the remaining oil life for the vehicle. Smart tile 504 presents an overall vehicle health score that may be indicative of a health of a summation of the individual vehicle components. Smart tile 508 may present information about the next upcoming service interval for the vehicle, as well as a remaining number of miles and/or amount of time until the service should be performed. Any of the smart tiles may also present any other information, such as vehicle tire pressure status, transmission fluid levels, and/or any other types of information. Additionally, one of the smart tiles in this interface may be selected by a user to present any of the user interfaces illustrated in FIGS. 1-4. That is, a user may select a particular smart tile and a replica of the in-vehicle cluster may be presented on the display of the mobile device 108. Additionally, the information presented in each of the smart tiles may be user-configurable. For example, a user may indicate that smart tile 502 should display tire pressure information and smart tile 504 should display odometer readings. That is, the example smart tiles presented in the figure are not intended to be limiting and any other information may be displayed. Additionally, the user interface 500 is merely an exemplary user interface, and any of the information described herein may similarly be presented in any other manner as well.

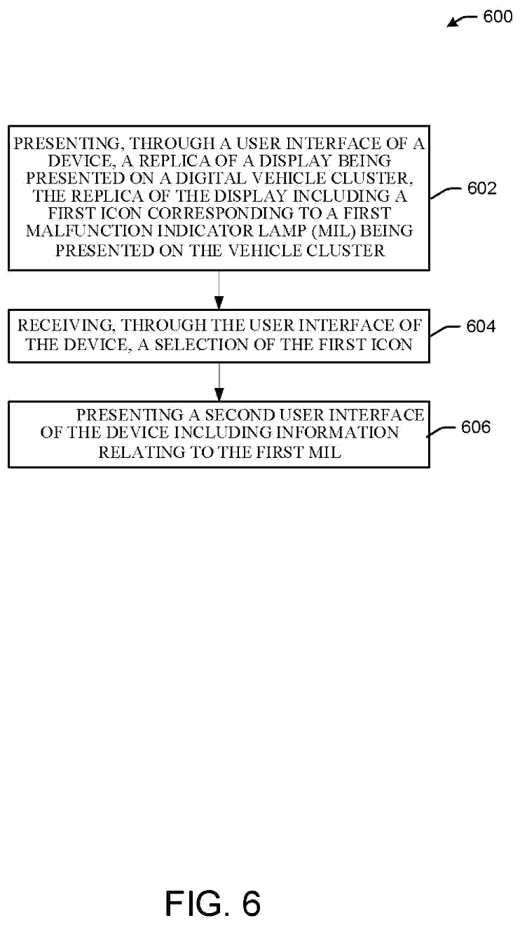

FIG. 6 illustrates an example method 600, in accordance with one or more embodiments of this disclosure. At block 602, the method 600 may include presenting, through a user interface of a device (for example, mobile device 108 and/or any other device described herein), an image of a display being presented on a digital vehicle cluster, the image of the display including a first icon corresponding to a first malfunction indicator lamp (MIL) being presented on the vehicle cluster. At block 604, the method 600 may include receiving, through the user interface of the device, a selection of the first icon. At block 606, the method 600 may include presenting a second user interface of the device including information relating to the first MIL.

In one or more embodiments, the image of the display is obtained from a database including a collection of in-vehicle cluster images for different types of vehicles.

In one or more embodiments, the image of the display further includes a second icon corresponding to a second malfunction indicator lamp (MIL) being presented on the vehicle cluster, wherein the method 500 may further includes receiving, through the user interface of the device, a selection of the second icon. The method may further include presenting a third user interface of the device including information relating to the second MIL, wherein the first MIL is a first type, the second MIL is a second type, and the first type and second type are different.

In one or more embodiments, the information includes a description of the first MIL.

In one or more embodiments, the information includes an indication of a process for remedying a vehicle status causing the presentation of the first MIL on the digital vehicle cluster.

In one or more embodiments, the information includes a date and/or time at which the first MIL was presented on the vehicle cluster. The information may also include any other types of information.

In one or more embodiments, the second user interface is a popup box that overlays a portion of the first user interface.

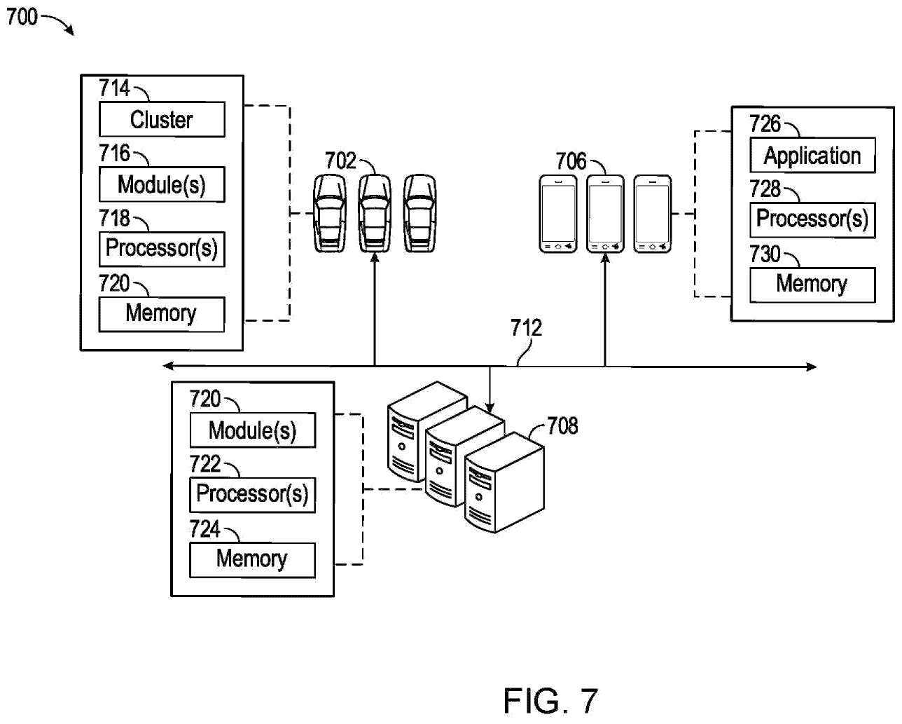

FIG. 7 illustrates an example of a system 700, in accordance with one or more embodiments of this disclosure. In one or more embodiments, the system 700 may include at least one or more vehicle(s) 702, one or more user device(s) 706, and/or one or more server(s) 708.

In one or more embodiments, a vehicle 702 may include any vehicle described herein, such as a vehicle that has already parked within a parking space, a vehicle that intends to park within a parking space, and/or vehicles in the vicinity that capture data relating to a vehicle parking job. A vehicle 702 may include any type of vehicle (for example, electric vehicle, hybrid vehicle, internal combustion engine vehicle, autonomous or semi-autonomous vehicle, etc.). A vehicle 702 may also include any elements described with respect to the vehicle 102 (such as the cluster 106 and the HMI 104), as well as any other elements. For example, the cluster 714 may be the same as the cluster 106. That is, the cluster 714 may be digital or analog and may present various types of information to a user. For example, the cluster 714 may include a tachometer to provide an indication of engine rotations per minute (RPMs), a speedometer to provide an indication of vehicle speed, an odometer to provide an indication of a number of vehicle miles, and/or any other types of information that may be relevant to the user. Additionally, the cluster 714 may, in some cases, present one or more MILs. A MIL may be presented based on a DTC being active in the vehicle. For example, if a low oil DTC is active in the vehicle, then a MIL associated with the low oil DTC may illuminate on the cluster to provide an indication to the user that the vehicle's oil may need to be changed.

In one or more embodiments, the one or more mobile devices 706 may include any type of device, such as a smartphone, desktop computer, laptop computer, and/or any other type of device. A mobile device 706 may include an application 726 that may present any of the information described herein to a user. For example, application 726 may present smart tiles (for example, as illustrated in FIG. 5) including vehicle health alerts and other information about a vehicle 702. The application 726 may also present the cluster 714 of the vehicle and may allow the user to interact with this duplicated cluster to view additional information about any MILs that are being presented on the cluster 714. For example, as described herein, a user may select the MIL through the application 726 and may be provided with a description of the MIL, as well as options to remedy the DTC associated with the MIL. The application 726 may also allow the user to perform any other functionality as described herein or otherwise.

Additionally, as mentioned above, any of the functionality provided by the application 726 may also be provided through any other type of system as well. For example, the HMI 104 of the vehicle may present similar information to a user and may facilitate similar user interaction as well.

In one or more embodiments, the one or more server(s) 708 may be remote server(s) that may be used to facilitate any of the functions described herein (for example, through one or more module(s) 720). For example, the server(s) 708 may facilitate providing data regarding the cluster 714 of the vehicle to the mobile device application 726 for presentation to the user. The server(s) 708 may also facilitate the presentation of any information regarding how to remedy a DTC, as well as any other functionality. For example, the server(s) 708 may include a database including links and contact information for service providers, such as dealerships, service centers, and/or the like that a user may schedule an appointment with to perform maintenance on a vehicle 702 to address a particular MIL. The server(s) 708 may also store any other information and/or may facilitate any other functionality as well.

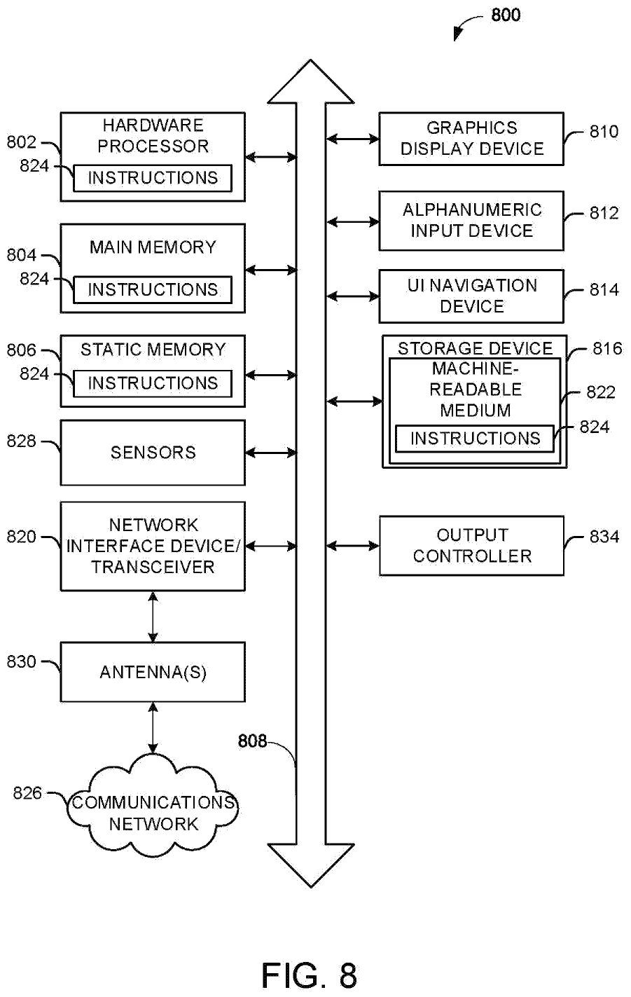

In one or more embodiments, any of the one or more vehicles 702, one or more mobile devices 706, and/or one or more servers 708 and/or any other elements of the system 700 may include any of the components of the machine 800 described with respect to FIG. 8. That is, as illustrated in the figure, these elements of the system 800 may include one or more processor(s) and memory, as well as at least any other elements described as being included in the machine 800. That is, although the figure may only depict a particular element of system 700 as having one or more processors, memory, and one or more modules, this may not be intended to be limiting in any way.

Furthermore, any reference to a single vehicle 702, mobile device 706, and/or server 708 may not be intended to be limiting and may similarly apply to any other number of vehicles 702, mobile devices 706, and/or servers 708 as well.

FIG. 8 depicts a block diagram of an example machine 800 upon which any of one or more techniques (e.g., methods) may be performed, in accordance with one or more example embodiments of the present disclosure. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a network interface device/transceiver 820 coupled to antenna(s) 830, and one or more sensors 828, such as a global positioning system (GPS) sensor, a compass, an accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, certain systems and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed:

1. A method comprising:
presenting, through a first user interface of a device, an image of a display being presented on a digital vehicle cluster, the image of the display including a first icon corresponding to a first malfunction indicator lamp (MIL) being presented on the digital vehicle cluster;
receiving, through the first user interface of the device, a selection of the first icon; and
presenting a second user interface of the device including information relating to the first MIL.

2. The method of claim 1, wherein the image of the display further includes a second icon corresponding to a second malfunction indicator lamp (MIL) being presented on the digital vehicle cluster, wherein the method further comprises:
receiving, through the first user interface of the device, a selection of the second icon; and
presenting a third user interface of the device including information relating to the second MIL, wherein the first MIL is a first type, the second MIL is a second type, and the first type and second type are different.

3. The method of claim 1, wherein the information includes a description of the first MIL.

4. The method of claim 1, wherein the information includes an indication of a process for remedying a vehicle status causing the presentation of the first MIL on the digital vehicle cluster.

5. The method of claim 1, wherein the information includes a date and/or time at which the first MIL was presented on the digital vehicle cluster.

6. The method of claim 1, wherein the second user interface is a popup box that overlays a portion of the first user interface.

7. The method of claim 1, wherein the image of the display is obtained from a database including a collection of in-vehicle cluster images for different types of vehicles.

8. A non-transitory computer-readable medium storing computer-executable instructions, that when executed by a processor, cause the processor to:
present, through a first user interface of a device, an image of a display being presented on a digital vehicle cluster, the image of the display including a first icon corresponding to a first malfunction indicator lamp (MIL) being presented on the digital vehicle cluster;
receive, through the first user interface of the device, a selection of the first icon; and
present a second user interface of the device including information relating to the first MIL.

9. The non-transitory computer-readable medium of claim 8, wherein the image of the display further includes a second icon corresponding to a second malfunction indicator lamp (MIL) being presented on the digital vehicle cluster, wherein the computer-executable instructions further cause the processor to:
receive, through the first user interface of the device, a selection of the second icon; and
present a third user interface of the device including information relating to the second MIL, wherein the first MIL is a first type, the second MIL is a second type, and the first type and second type are different.

10. The non-transitory computer-readable medium of claim 8, wherein the information includes a description of the first MIL.

11. The non-transitory computer-readable medium of claim 8, wherein the information includes an indication of a process for remedying a vehicle status causing the presentation of the first MIL on the digital vehicle cluster.

12. The non-transitory computer-readable medium of claim 8, wherein the information includes a date and/or time at which the first MIL was presented on the digital vehicle cluster.

13. The non-transitory computer-readable medium of claim 8, wherein the second user interface is a popup box that overlays a portion of the first user interface.

14. The non-transitory computer-readable medium of claim 8, wherein the image of the display is obtained from a database including a collection of in-vehicle cluster images for different types of vehicles.

15. A system comprising:
a processor; and
a memory storing computer-executable instructions, that when executed by the processor, cause the processor to:
present, through a first user interface of a device, an image of a display being presented on a digital vehicle cluster, the image of the display including a first icon corresponding to a first malfunction indicator lamp (MIL) being presented on the digital vehicle cluster;
receive, through the first user interface of the device, a selection of the first icon; and
present a second user interface of the device including information relating to the first MIL.

16. The system of claim 15, wherein the image of the display further includes a second icon corresponding to a second malfunction indicator lamp (MIL) being presented on the digital vehicle cluster, wherein the computer-executable instructions further cause the processor to:
receive, through the first user interface of the device, a selection of the second icon; and
present a third user interface of the device including information relating to the second MIL, wherein the first MIL is a first type, the second MIL is a second type, and the first type and second type are different.

17. The system of claim 15, wherein the information includes a description of the first MIL.

18. The system of claim 15, wherein the information includes an indication of a process for remedying a vehicle status causing the presentation of the first MIL on the digital vehicle cluster.

19. The system of claim 15, wherein the second user interface is a popup box that overlays a portion of the first user interface.

20. The system of claim 15, wherein the image of the display is obtained from a database including a collection of in-vehicle cluster images for different types of vehicles.
